(19) United States
(12) Patent Application Publication
(10) Pub. No.: US 2007/0195822 A1
(43) Pub. Date: Aug. 23, 2007

(54) Method and system for locating packet boundaries

(75) Inventors: Yi-Fu Chen, Taipei City (TW); Rong-Liang Chiou, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/358,202

(22) Filed: Feb. 21, 2006

(51) Int. Cl. H04J 3/00

(52) U.S. Cl. 370/476; 370/474

(57) ABSTRACT

A method and system for locating packet boundaries in a bit stream. The method comprises generating a checksum from a first bit stream, and recovering the first bit stream according an intermediate result which is generated during the checksum processing. The step of generating the checksum comprises dividing the first bit stream by a first polynomial to obtain a second bit stream, delaying the second bit stream by a first delay amount to form a third bit stream, multiplying the third bit stream by a second polynomial to obtain a fourth bit stream, adding the second and fourth bit streams to form a fifth bit stream, and correlating the fifth bit stream with a preset pattern to output a sync signal. The input bit stream can be recovered according to the third bit stream. The sync signal indicates the location of the packet boundary in the delayed first bit stream.

### BACKGROUND

The invention relates to packet framing in a communication system, and more particularly, to MPEG-2 transport packet framing in a communication system.

When two communication blocks with different formats are concatenated, a data segmentation or reassembly is generally required at the interface of two communication blocks. An interface device performing data segmentation and reassembly accepts input data from one communication block and issues an appropriate output data format for the another communication block.

An interface device is commonly required in modern telecommunication systems. For example, a standard for the North American digital cable television service system, ITU-T R/J.83B, specifies an MPEG framing device between two blocks which accepts different data formats. FIG. 1 shows a block diagram of a communication system including MPEG-2 encoder 102, MPEG framing device 106 and FEC (Forward Error Correcting) encoder 104 in transmitter 12 and FEC decoder 108, MPEG delineating device 112 and a MPEG-2 decoder 110 in receiver 14. The MPEG-2 encoder 102 generates MPEG-2 transport packet. FIG. 2a shows a frame structure of MPEG-2 transport packet. A MPEG-2 transport packet has 188 bytes, with one byte for synchronization, followed by a 187 byte payload. The first byte of a MPEG-2 transport packet is specified to be a sync byte having a preset constant value of 47_{HEX} (0100_{—}0111).

To fully utilize the information bearing capacity of this sync byte, the MPEG-2 transport packet is not sent to FEC encoder 104 in FIG. 1 directly. The MPEG framing device 106 in FIG. 1 adds a parity checksum in the MPEG-2 transport packet, which supplies improved packet delineation functionality, and error detection capability independent of the RS decoding. The checksum is computed by passing the 187 byte (1496 bits) payload through a checksum generator constituting of linear feedback shift registers (LFSR) as described by the following equation:
f(X)=[1+X¹⁴⁹⁷*b(X)] /g(X),
where g(X)=1 +X+X⁵+X⁶+X⁸ and b(X)=1+X+X³+X⁷. All addition operations are assumed to be modulo 2. The LFSR performing the above equation is shown in FIG. 3. The 1496 bits which constitute the MPEG-2 transport packet payload are first shifted into the checksum generator. The checksum generator input is set to zero after the 1496 data bits are received, and eight additional shifts are required to sequentially output the eight computed syndrome bits. This 8-bit result must then be passed through an additional FIR filtering function g(x) (initialized to an all-zeros state prior to introduction of the 8 syndrome bits) to generate an encoder checksum. An offset of 67_{HEX} is added to this encoder checksum result for improved packet delineation functionality. The final 8-bit checksum with added offset is transmitted MSB first following the 1496 payload bits.

The modified MPEG-2 transport packet as shown in FIG. 2b is sent to cable channel 16, and is received by the receiver 14. Because the MEPG-2 decoder 110 can only receive an MPEG-2 transport packet, an MPEG delineating device 112 is required. Due to other function blocks in the transmitter 12 and receiver 14, such as FEC encoder and decoder 104 and 108, the received stream is not as compact as transmitted. FIG. 4 shows an example of a received bit stream. The MPEG delineating device 112 delineates the received bit stream into an MPEG-2 transport packet. The MPEG delineating device 112 determines where the boundaries of the MPEG-2 frames are from the bit stream. Typically, the packet boundaries are delineated according to the checksum.

To identify a valid checksum from the bit stream, a parity check matrix is required. A received vector R represents the MPEG-2 data consisting of 187 bytes followed by the checksum byte, yielding a total of 1504 bits. This R vector is multiplied by the parity check matrix P, yielding an S vector whose length is 8-bits, as illustrated in FIG. 10. Each of the 8 columns of the parity check matrix P includes a 1497 bit vector, hereafter referred to as C. Column vector C is defined in FIG. 11. The 1497-bit column C is duplicated in subsequent columns of the matrix P, shifted down by one bit position. The positions unoccupied by the column data are filled with zeros, as illustrated in FIG. 12. Since the checksum has been designed such that when the appropriate 188 bytes of the modified MPEG-2 transport stream packet are multiplied with the parity check matrix, a valid checksum will be indicated when the calculated product produces a 47_{Hex} result.

An equivalent calculation of multiplying the R vector with the P matrix is multiplying the R vector with f(x), where f(x) is [1+X¹⁴⁹⁷*b(X)]/g(X), g(X)=1+X+X⁵+X⁶+X⁸ and b(X) =1+X+X³+X⁷. A syndrome generator as shown in FIG. 13 with an offset of zero is employed for this purpose.

Conventionally, delineating device 112 as shown in FIG. 5 requires two memories. Decoded symbols are not only inserted into delay line 44, but also inserted into an LFSR 42 to obtain an 8-bit syndrome. Each delay line with size equals to the size of an output transport packet, i.e. 1497 bits, which increases the cost of the MPEG delineating device. Delay line 44 stores the data to be output, and delay line in the LFSR 42 stores the intermediate results for delineating the MPEG-2 transport packet. When the payload of an MPEG-2 transport packet is inserted into the syndrome generator, a valid checksum of 47ₕₑₓ is output. Meanwhile, the payload is output from the delay line 44.

### SUMMARY

Accordingly, the invention provides a method and system for locating a packet boundary from a bit stream with less memory. The invention provides a method of generating a checksum of a first bit stream, and recovers the first bit stream according an intermediate result which is produced during the checksum processing. The step of generating the checksum comprises dividing the first bit stream by a first polynomial to obtain a second bit stream, delaying the second bit stream by a first delay amount to form a third bit stream, multiplying the third bit stream by a second polynomial to obtain a fourth bit stream, adding the second and fourth bit streams to form a fifth bit stream, and correlating the fifth bit stream with a preset pattern to output a sync signal. The step of recovering the input bit stream comprises delaying the third bit stream by a second delay amount to obtain a sixth bit stream, wherein the third bit stream is the intermediated result when processing the checksum, and multiplying the sixth bit stream by the first polynomial to form a delayed first bit stream. The sync signal indicates the location of the packet boundary in the delayed first bit stream.

In another embodiment of the invention, the steps of delaying the intermediated result of processing the checksum, then multiplying it with a second polynomial can be switched without affecting the result of locating the packet boundary.

A system for locating packet boundaries from a first bit stream is also provided in the invention, comprising a dividing unit, a first delay line, a second delay line, a first multiplying unit, an adder, a correlator, and a second multiplying unit. The dividing unit divides the first bit stream by a first polynomial to output a second bit stream. The first delay line, connected to the dividing unit, delays the second bit stream by a first delay amount to output a third bit stream. The second delay line, connected to the first delay line, delays the third bit stream by a second delay amount to output a fourth bit stream. The first multiplying unit, connected to the first delay line, multiplies the third bit stream by a second polynomial to output a fifth bit stream. The adder, connected with the dividing unit and the first multiplying unit, adds the second and fifth bit streams to output a sixth bit stream. The correlator, connected to the adder, correlates the sixth bit stream with a preset pattern to output a sync signal. The second multiplying unit, connected to the second delay line, multiplies the fourth bit stream by the first polynomial to form a delayed first bit stream. The sync signal indicates the location of the packet boundary in the delayed first bit stream. In other embodiment of the invention, the third bit stream can be multiplied by the first polynomial, then the multiplied third bit stream can be delayed by the second delay line. In other words, the second multiplier and the second delay line can be switched without affecting the result of locating the packet boundary.

Another system for delineating a packet from a first bit stream is also provided, comprises an input terminal, a dividing unit, a serial-to-parallel converter, a first parallel-to-serial converter, a second parallel-to-serial converter, a memory array, a first multiplying unit, a second multiplying unit, an adder and a correlator. The input terminal receives the first bit stream. The dividing unit, connected to the input terminal, divides the first bit stream by a first polynomial to output a second bit stream. The serial-to-parallel converter, connected to the dividing unit, converts the second bit stream into a first N-bit symbol stream with N being integer. The memory array, connected to the serial-to-parallel converter, stores the first N-bit symbol stream, and outputs a second and third N-bit symbol stream. The second and third symbol streams are delayed versions of the first symbol stream. The first parallel-to-serial converter, connected to the memory array, converts the second symbol stream into a third bit stream. The second parallel-to-serial converter, connected to the memory array, converts the third symbol stream into a fourth bit stream. The first multiplying unit, connected to the first parallel-to-serial converter, multiplies the third bit stream by a second polynomial to output a fifth bit stream. The adder, connected to the dividing unit and the first multiplying unit, adds the second and fifth bit streams to output a sixth bit stream. The correlator, connected to the adder, correlates the sixth bit stream with a preset pattern to output a sync signal. The second multiplying unit, connected to the second parallel-to-serial converter, multiplies the fourth bit stream by the first polynomial to form a delayed first bit stream. The sync signal indicates the location of the packet boundary in the delayed first bit stream. In other embodiment of the invention, the second multiplier and the second parallel-to-serial converter can be switched without affecting the result of locating the packet boundary.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the present invention.

FIG. 1 shows a block diagram of a communication system including an MPEG framing device in a transmitter and another MPEG framing device in a receiver;

FIG. 2a shows a frame structure of an MPEG-2 transport packet;

FIG. 2b shows a modified MPEG-2 transport packet;

FIG. 3 shows an LFSR computing a checksum of an MPEG-2 transport packet;

FIG. 4 shows an example of a received bit stream;

FIG. 5 shows a block diagram of a conventional MPEG delineating-device;

FIG. 6 shows a diagram of a system 112 for synchronizing MPEG-2 transport packet according to the invention;

FIG. 7a shows a block diagram of delineating a packet boundary according to an embodiment of the invention;

FIG. 7b shows another block diagram of generating a signal indicating the synchronization of a packet;

FIG. 7c shows the detailed structure of delineating the packet according to an embodiment of the invention;

FIG. 8a shows a block diagram of delineation a packet from a input bit stream according to another embodiment of the invention;

FIG. 8b shows a another block diagram of delineation a packet from a input bit stream according to another embodiment of the invention;

FIG. 9 is a flowchart of a method 900 for delineating a packet from a bit stream according to an embodiment of the invention;

FIG. 10 shows the received MPEG-2 and parity check matrix multiplication;

FIG. 11 is the column vector C; and

FIG. 12 shows the positions unoccupied by the column data are filled with zeros.

FIG. 13 is a syndrome generator.

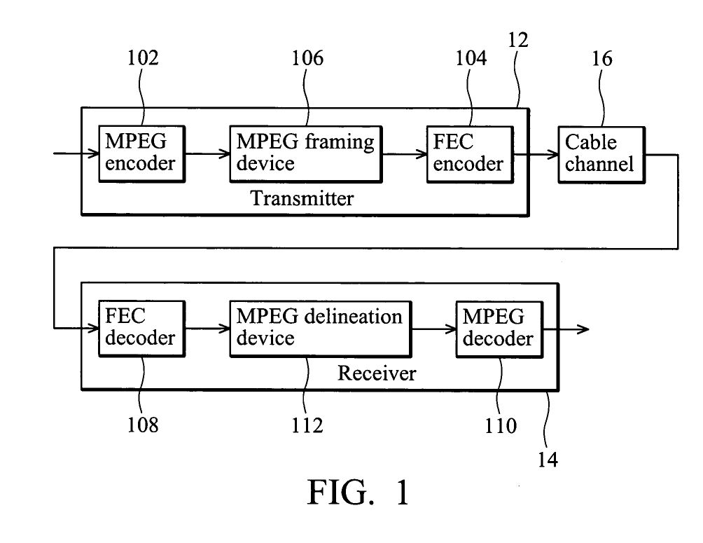

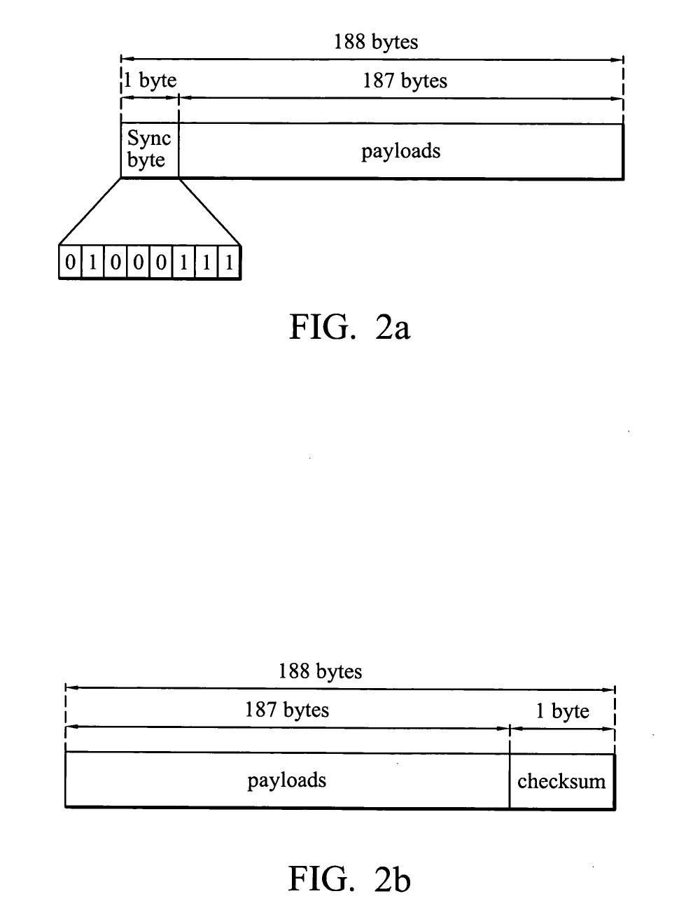

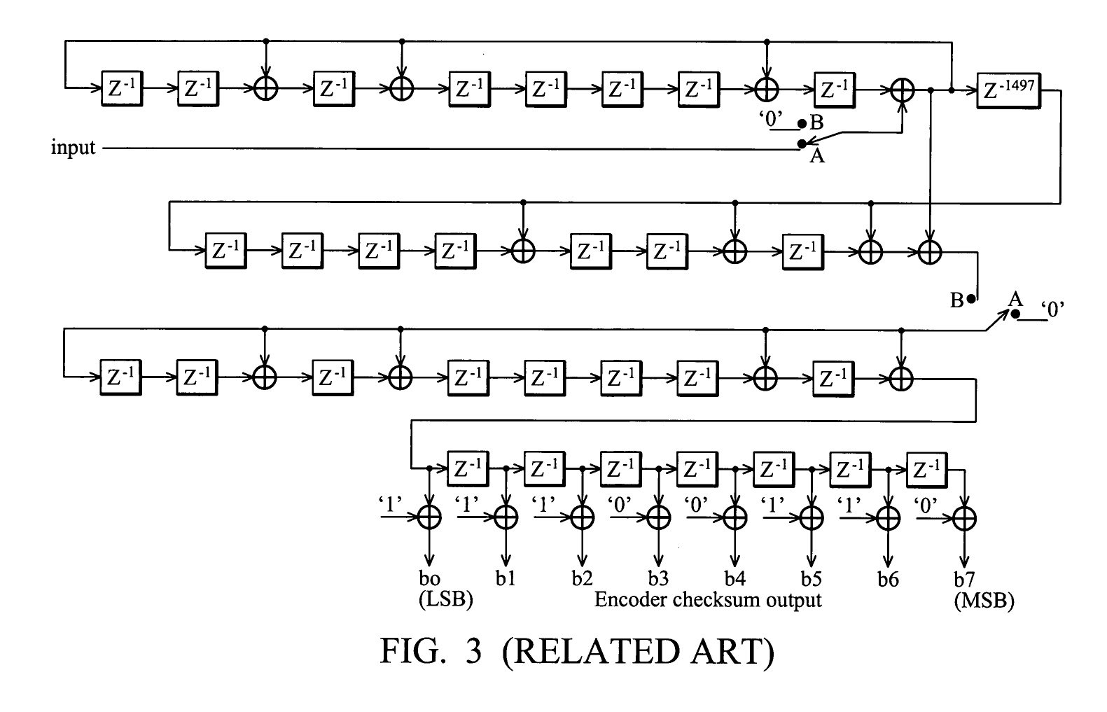

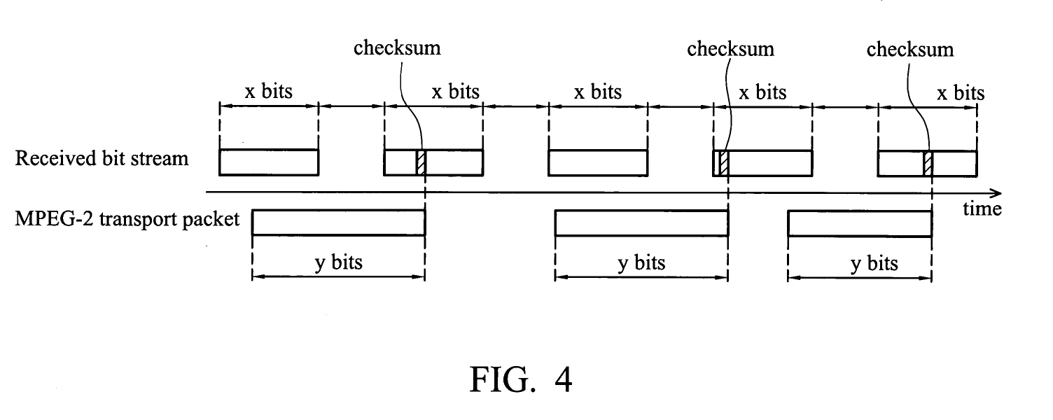

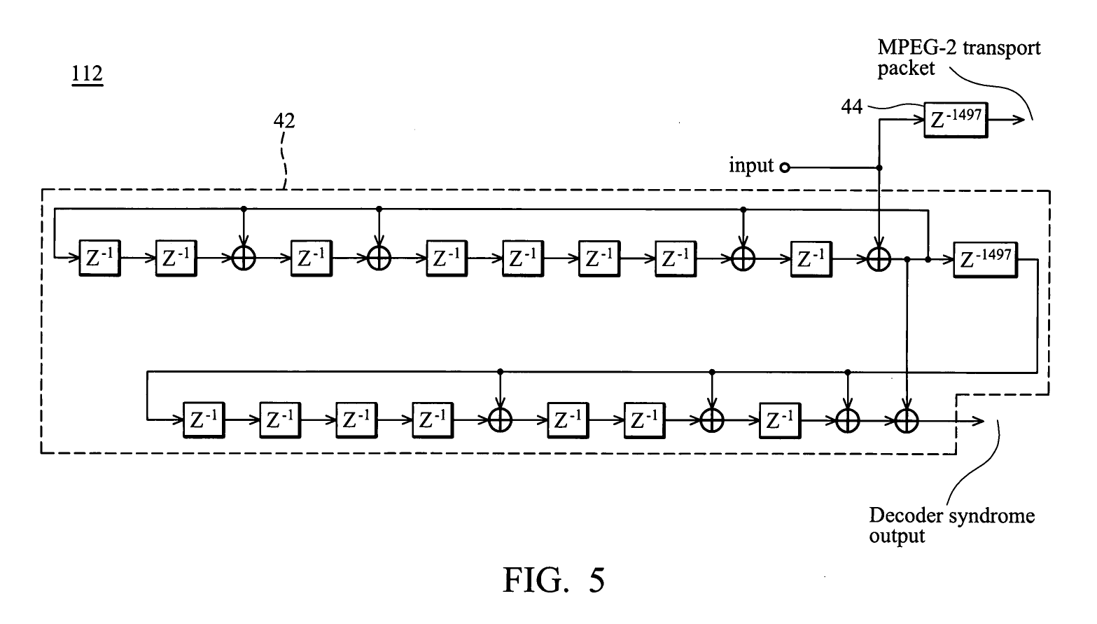

### DETAILED DESCRIPTION

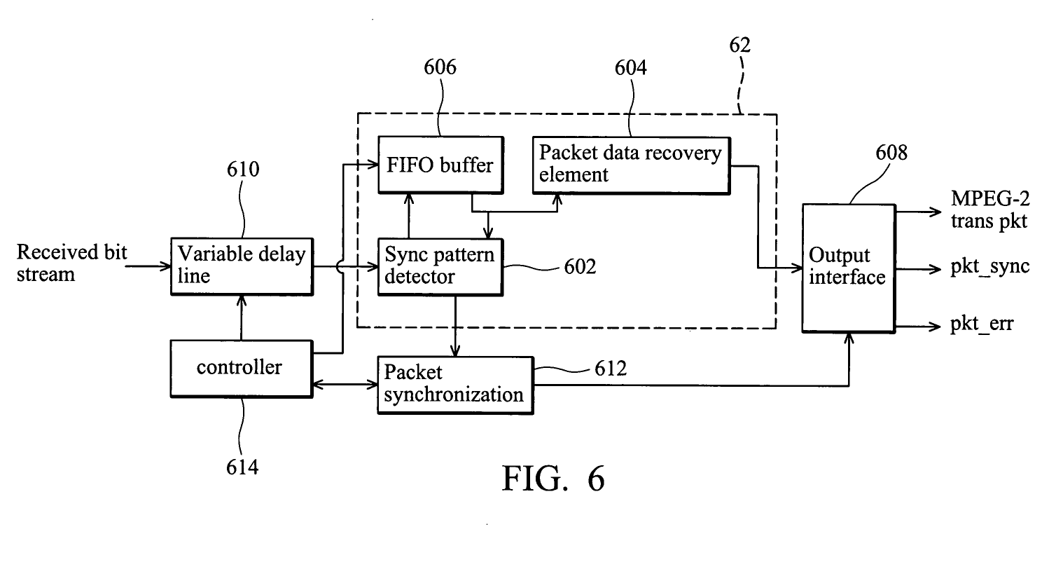

FIG. 6 shows the diagram of a system 112 for synchronizing MPEG-2 transport packet according to the invention. The system comprises a sync pattern detector 602, a packet data recovery element 604, a FIFO (first-in first-out) buffer 606, an output interface 608, a variable delay line 610, a packet synchronizer 612 and a controller 614. The variable delay line 610 receives a data stream consisting of a modified MPEG-2 transport packet. The sync pattern detector 602 is a decoder decoding the input streaming data to obtain the syndrome. The packet data recovery element 604 recovers the received stream to form an MPEG-2 transport packet. The FIFO buffer 606 provides necessary memory for detecting a sync pattern and recovering data. The packet synchronization 612 receives the valid checksum, 47ₕₑₓ, and a sync signal, then sends synchronizing information to interface 608. The controller 614 controls the operation and interactions between the described blocks.

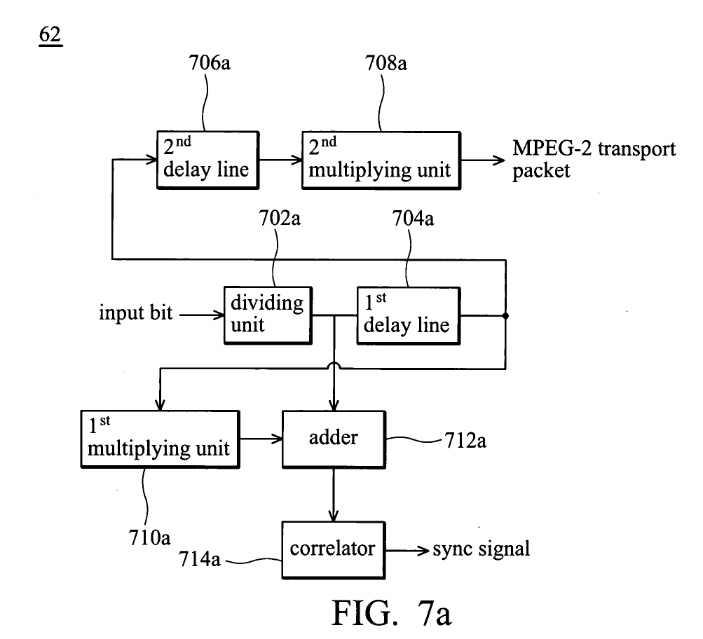

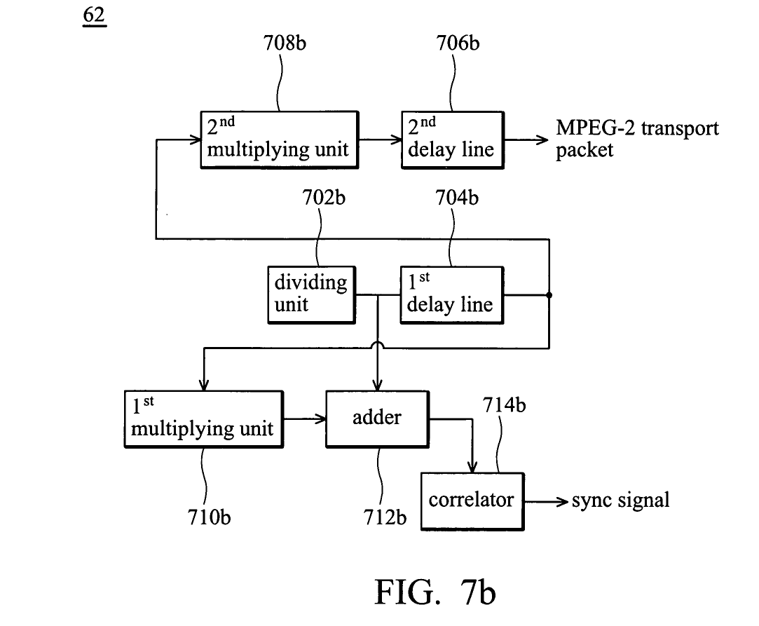

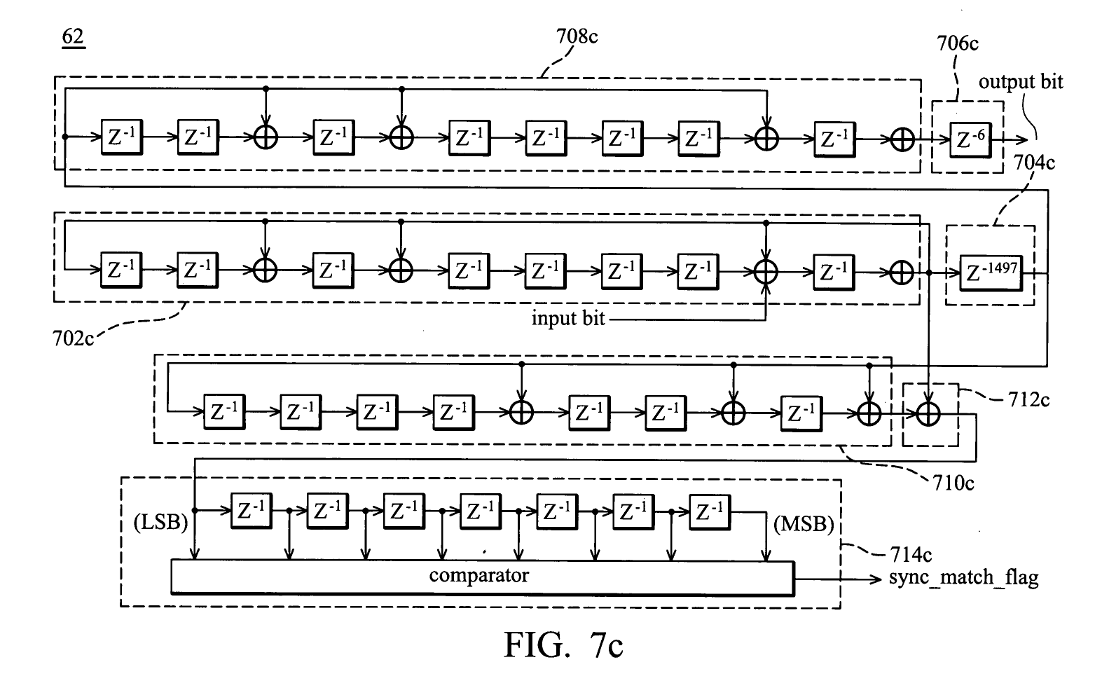

FIG. 7a shows a block diagram of delineating a packet boundary. The received bit stream data is input to a dividing unit 702a. The dividing unit 702a divides the input stream by a first polynomial g (x) to obtain a second bit stream, where g(X)=1+X+X⁵+X⁶+X⁸. A first delay line 704a connects to the dividing unit 702a, delaying the second bit stream by a first delay amount to output a third bit stream. The first delay amount is N₁ bits, where N₁ in this embodiment is the length of payloads bits, 1497. A second delay line 706a connects to the first delay line 704a, delaying the third bit stream by a second delay amount to output a fourth bit stream. The second delay amount is N₂−2 bits, where N₂ is the checksum length of 8 bits. A first multiplying unit connected to the first delay line 704a, multiplying the third bit stream by a second polynomial b(x) to output a fifth bit stream, where b(x)=1+X+X³+X⁷. An adder 712a connected to the dividing unit 702a and the first multiplying unit 710a, adding the second and fifth bit streams to output a sixth bit stream. A correlator 714a connected to the adder 712a, correlating the sixth bit stream with a preset pattern to output a sync signal, where the sync signal indicates the location of the packet boundary. The preset pattern is as same as a valid checksum, 47ₕₑₓ, in this embodiment. A second multiplying unit 708a connected to the second delay line, multiplying the fourth bit stream by the first polynomial to form a delayed first bit stream.

FIG. 7b shows another block diagram of generating a signal indicating the synchronization of a packet. The sub-blocks are as same as shown in FIG. 7a, though the arrangement of the second multiplying unit 708b and the second delay line 706b is slightly different from FIG. 7a. Because multiplying and delaying are both linear operations, the placement of the two blocks 706 and 708 can be switched.

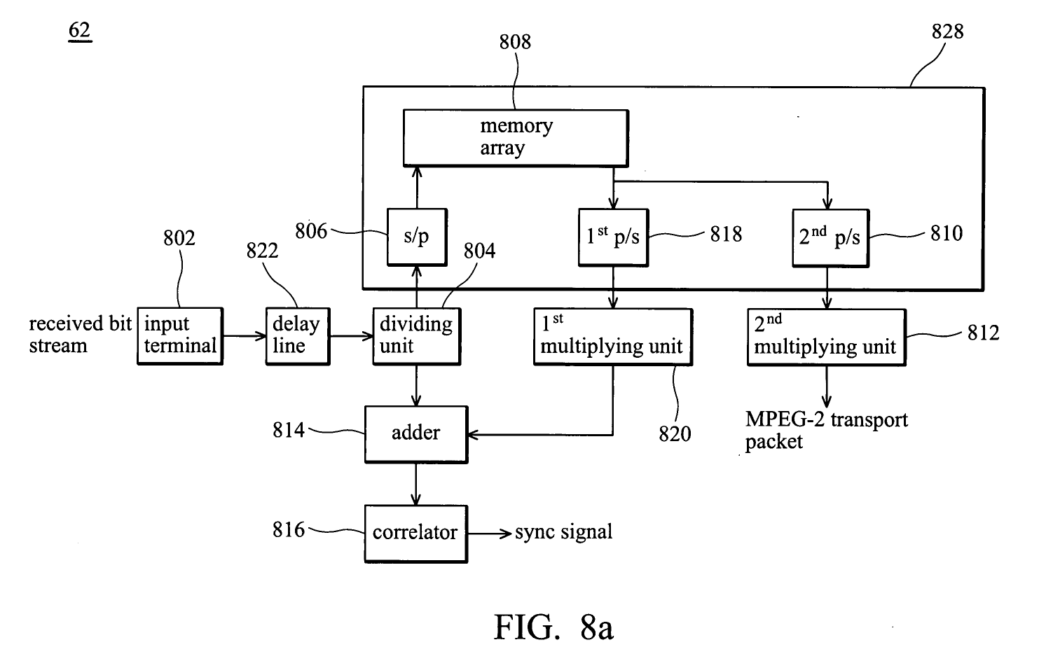

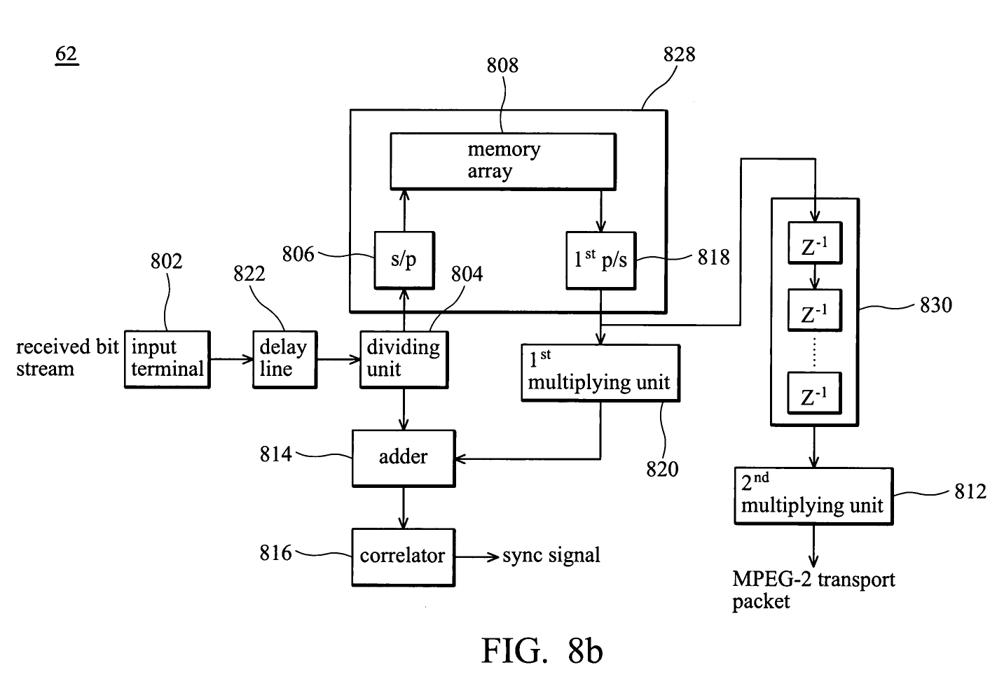

FIG. 7c shows a detailed structure of delineating the packet according to an embodiment of the invention shown in FIG. 7b. The dividing unit 702c is dedicated to dividing an input bit stream with a first polynomial g(x), where g(x)=1+X+X⁵+X⁶+X⁸. The first multiplying unit 710c is dedicated to multiplying a second polynomial b(x), where b(x)=1 +X +X³+X⁷. The second multiplying unit 708c is dedicated to multiplying the first polynomial g(x). The correlator 714c comprises a 8-tap delay line and a comparator. When the value of the 8-tap delay line equals 47ₕₑₓ, the comparator sends a sync signal. Note that, as shown in the FIG. 7a, the second multiplying unit 708c and the second delay line 706c are interchangable. FIG. 8a shows a block diagram of delineating a packet from an input bit stream according to another embodiment of the invention. In the embodiment of the invention, the first and second delay lines 704a and 706a shown in the FIG. 7a are implemented by a memory device 828. The system 62 comprises an input terminal 802, a dividing unit 804, a memory device 828, two multiplying units 820 and 812, an adder 814 and a correlator 816. The memory device 828a comprises a serial-to-parallel converter 806, a memory array 808, and two parallel-to-serial converters 818 and 810. The input terminal 802 receives an input bit stream which includes payload bytes and/or checksum bytes of a modified MPEG-2 transport packet. The dividing unit 804, connected to the input terminal 802, divides the received bit stream by a first polynomial to output a second bit stream. The serial-to-parallel converter 806 connected to the dividing unit 804, converting the second bit stream into a first N-bit symbol stream with N being an integer. The memory array 808, connected to the serial-to-parallel converter 806, stores the first N-bit symbol stream and outputs a second and third N-bit symbol stream, where the second and third symbol streams are delayed versions of the first symbol stream. The first parallel-to-serial converter 818, connected to the memory array 808, converts the second N-bit symbol stream into a third bit stream. The second parallel-to-serial converter 810, connected to the memory array 808, converts the second symbol stream into a fourth bit stream. The first multiplying unit 820, connected to the first parallel-to-serial converter 818, multiplies the third bit stream by a second polynomial to output a fifth bit stream. The adder 814, connected to the dividing unit 804 and the first multiplying unit 820, adds the second and fifth bit streams to output a sixth bit stream. The correlator 816, connected to the adder 814, correlates the sixth bit stream with a preset pattern to output a sync signal. The second multiplying unit 812, connected to the second parallel-to-serial converter 810, multiplies the fourth bit stream by the first polynomial to form a delayed first bit stream. The sync signal indicates the location of the packet boundary in the delayed first bit stream. In this embodiment, the memory device 828 is a dual-port memory. In other embodiments of the invention, the memory device 828 is a single-port memory. In the case of memory device 828 a single-port memory, an additional delay line 822 may be needed such that a writing timing and a reading timing of the memory device 828 is not the same.

FIG. 8b shows another detailed implementation of the embodiment shown in FIG. 7a, wherein only the first delay line 704a in the FIG. 7a is implemented by the memory device. FIG. 8b is the same as FIG. 8a except that the second delay line 706a in FIG. 7a is implemented by a plurality of delay units 830, e.g. D-type flip-flops. Note that, the plurality of delay units 830 and the second multiplying unit 812 are interchangeable, since they both performs linear operations.

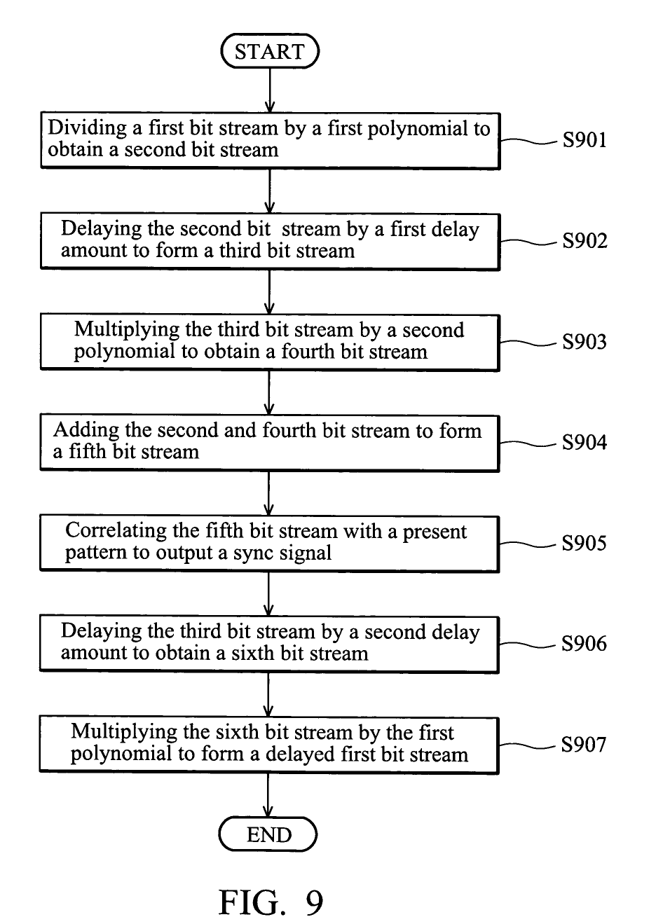

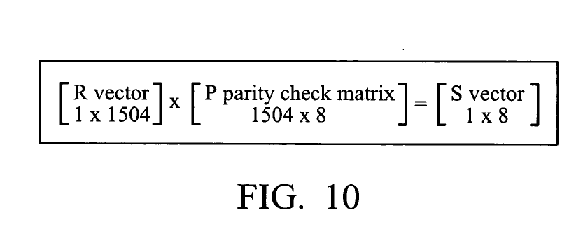

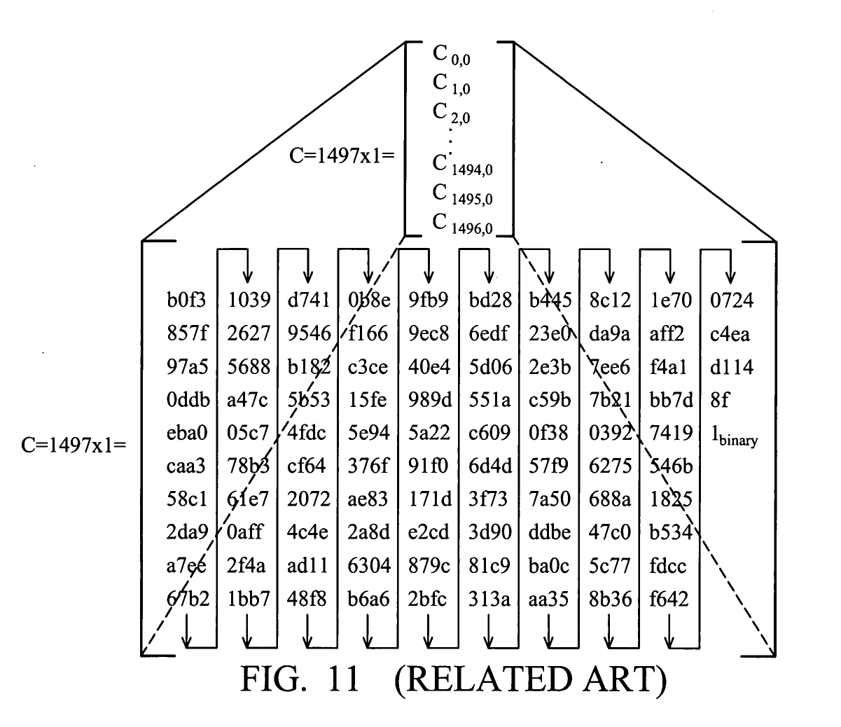

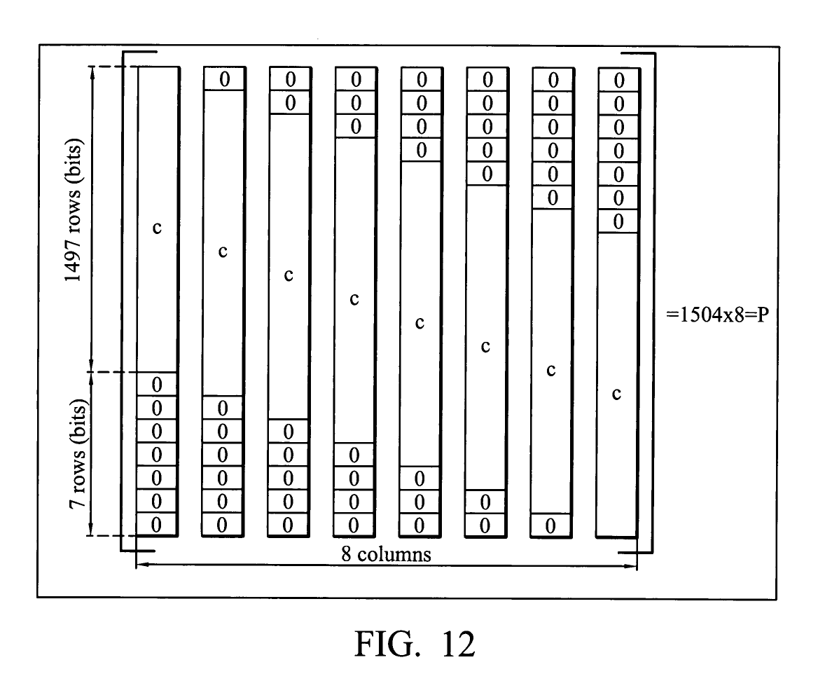

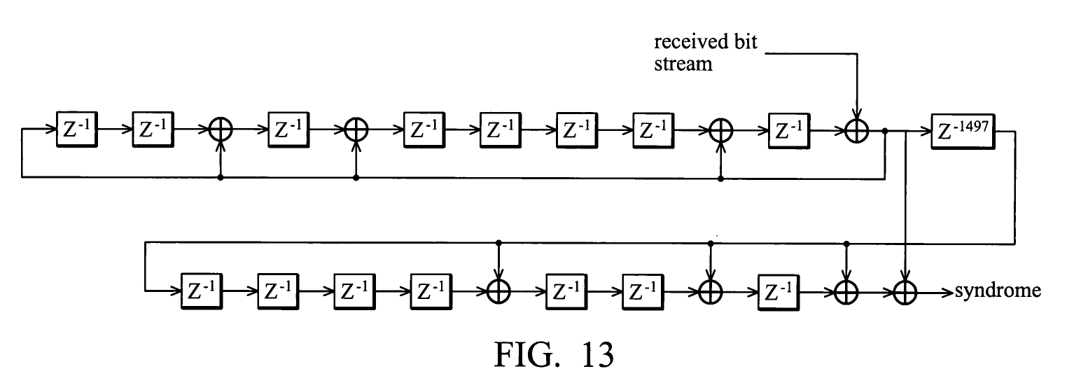

FIG. 9 is a flowchart of a method 900 for delineating a packet from a bit stream according to an embodiment of the invention. After receiving a first bit stream, the first bit stream is divided by the first polynomial g(x) to obtain a second bit stream, in step S901. In step S902, the second bit stream is delayed by a first delay amount to form a third bit stream. The first delay amount is N₁ bits, where N₁ in this embodiment is the length of payloads bits, 1497. The third bit stream is multiplied by a second polynomial b(x) to obtain a fourth bit stream, in step S903. In step S904, the second and fourth bit streams are added to form a fifth bit stream. In step S905, the fifth bit stream with a preset pattern is correlated to output a sync signal. The preset pattern is the same as a valid checksum, 47ₕₑₓ, in this embodiment. In step S906, the third bit stream is delayed by a second delay amount to obtain a sixth bit stream. The second delay amount is N₂−2 bits, where N₂ is the length of checksum, 8 bits. In step S907, the sixth bit stream is multiplied by the first polynomial to form a delayed first bit stream. The sync signal indicates the location of the packet boundary in the delayed first bit stream.

In method 900, a checksum of an MPEG-2 transport packet is calculated. The intermediate result of obtaining the checksum, the third bit stream, is further used to recover the received MPEG-2 transport packet. Similarly, because multiplying and delaying are both linear and non-causal operations, the steps S906 and S907 can be switched without changing the results of generating checksum and recovering received data.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for locating a packet boundary from a first bit stream, comprising: dividing the first bit stream by a first polynomial to obtain a second bit stream;
delaying the second bit stream by a first delay amount to form a third bit stream;
multiplying the third bit stream by a second polynomial to obtain a fourth bit stream;
adding the second and fourth bit streams to form a fifth bit stream;
correlating the fifth bit stream with a preset pattern to output a sync signal;
delaying the third bit stream by a second delay amount to obtain a sixth bit stream; and
multiplying the sixth bit stream by the first polynomial to form a delayed first bit stream;
wherein the sync signal indicates the location of the packet boundary in the delayed first bit stream.

2. The method as claimed in claim 1, wherein the first polynomial is (1+X+X⁵+X⁶+X⁸).

3. The method as claimed in claim 1, wherein the second polynomial is (1+X+X³+X⁷).

4. The method as claimed in claim 1, wherein the packet consists of a payload section having N₁ bits and a checksum section having N₂ bits, the first delay amount is equal to (N₁+1) bits and the second delay amount is equal to (N₂−2) bits.

5. The system as claimed in claim 4, wherein N₁=1496 and N₂=8.

6. The method as claimed in claim 1, wherein the packet preset pattern is equal to 47_{HEX}.

7. The method as claimed in claim 1, wherein the packet is a MPEG-2 transport packet.

8. A method for locating a packet boundary from a first bit stream, comprising:
dividing the first bit stream by a first polynomial to obtain a second bit stream;
delaying the second bit stream by a first delay amount to form a third bit stream;
multiplying the third bit stream by a second polynomial to obtain a fourth bit stream;
adding the second and fourth bit streams to for a fifth bit stream;
correlating the fifth bit stream with a preset pattern to output a sync signal; multiplying the third bit stream by the first polynomial to obtain a sixth bit stream;
delaying the sixth bit stream by a second delay amount to form a delayed first bit stream; and
wherein the sync signal indicates the location of the packet boundary in the delayed first bit stream.

9. The method as claimed in claim 8, wherein the first polynomial is (1+X+X⁵+X⁶+X⁸).

10. The method as claimed in claim 8, wherein the second polynomial is (1+X+X³+X⁷).

11. The method as claimed in claim 8, wherein the packet consists of a payload section having N₁ bits and a checksum section having N₂ bits, the first delay amount is equal to (N₁+1) bits and the second delay amount is equal to (N₂−2) bits.

12. The system as claimed in claim 11, wherein N₁=1496 and N₂=8.

13. The method as claimed in claim 8, wherein the packet preset pattern equals to 47_{HEX}.

14. The method as claimed in claim 8, wherein the packet is a MPEG-2 transport packet.

15. A system for locating a packet boundary from a first bit stream, comprising:
a dividing unit for dividing the first bit stream by a first polynomial to output a second bit stream;
a first delay line connected to the dividing unit, delaying the second bit stream by a first delay amount to output a third bit stream;
a first multiplying unit connected to the first delay line, multiplying the third bit stream by a second polynomial to output a fifth bit stream;
an adder connected to the dividing unit and the first multiplying unit, adding the second and fifth bit streams to output a sixth bit stream;
a correlator connected to the adder, correlating the sixth bit stream with a preset pattern to output a sync signal; and
a processing unit connected to the first delay line, for delaying and multiplying the third bit stream by the first polynomial to form a delayed first bit stream;
wherein the sync signal indicates the location of the packet boundary in the delayed first bit stream.

16. The system as claimed in claim 15, wherein the processing unit comprises:
a second delay line connected to the first delay line, delaying the third bit stream by a second delay amount to output a fourth bit stream; and
a second multiplying unit connected to the second delay line, multiplying the fourth bit stream by the first polynomial to form the delayed first bit stream.

17. The system as claimed in claim 15, wherein the processing unit comprises:
a second multiplying unit connected to the first delay line, multiplying the third bit stream by the first polynomial to form a fourth bit stream; and
a second delay line connected to the second multiplying unit, delaying the fourth bit stream by a second delay amount to output the delayed first stream.

18. The system as claimed in claim 16, the first and second delay lines are implemented by a memory device.

19. The system as claimed in claim 18, further comprising a delay line for receiving and delaying the first bit stream and outputting the delayed first bit stream to the dividing unit.

20. The system as claimed in claim 16, the first delay line is implemented by a memory device and the second delay line is implemented by a plurality of delay units.

21. The system as claimed in claim 17, the first delay line is implemented by a memory device and the second delay line is implemented by a plurality of delay units.

22. The system as claimed in claim 15, wherein the first polynomial is (1+X+X⁵+X⁶+X⁸).

23. The system as claimed in claim 15, wherein the second polynomial is (1+X+X³+X⁷).

24. The system as claimed in claim 15, wherein the packet consists of a payload section having N₁ bits and a checksum section having N₂ bits, the first delay amount equals to (N₁+1) bits and the second delay amount equals to (N₂−2) bits.

25. The system as claimed in claim 24, wherein N₁=1496 and N₂=8.

26. The system as claimed in claim 15, wherein the packet preset pattern equals to 47_{HEX}.

27. The system as claimed in claim 15, wherein the packet is a MPEG-2 transport packet.
